(19) United States
(12) Patent Application Publication
(10) Pub. No.: US 2022/0222716 A1
(43) Pub. Date: Jul. 14, 2022

(54) ELECTRONIC APPARATUS AND CONTROL METHOD THEREOF

(71) Applicant: Samsung Electronics Co., Ltd., Suwon-si (KR)

(72) Inventors: Byounghwa LEE, Suwon-si (KR); Changhyub WOO, Suwon-si (KR); Jaehun UHM, Suwon-si (KR)

(21) Appl. No.: 17/668,993

(22) Filed: Feb. 10, 2022

Related U.S. Application Data
(63) Continuation of application No. PCT/KR2021/008634, filed on Jul. 7, 2021.

(30) Foreign Application Priority Data
Jan. 13, 2021 (KR) 10-2021-0004603

(51) Int. Cl. G06Q 30/02

(52) U.S. Cl. CPC G06Q 30/0283; G06Q 30/0241

(57) ABSTRACT

An electronic apparatus is provided. The electronic apparatus includes a communication circuitry, a memory configured to store a first neural network model; and a processor configured to be connected to the communication circuitry and the memory to control the electronic apparatus, wherein the processor is configured to, based on a price request signal for advertising content to be provided to a viewer being received from an external device through the communication circuitry, obtain first information related to the viewer based on the price request signal, input the first information, second information on a target viewer and target viewing content set by an advertiser of the advertising content into the first neural network model to obtain an expected participation degree in the advertising content of the viewer, and determine whether to respond to the price request signal based on the expected participation degree.

### CROSS-REFERENCE TO RELATED APPLICATION(S)

This application is a continuation application, claiming priority under § 365(c), of an International application No. PCT/KR2021/008634, filed on Jul. 7, 2021, which is based on and claims the benefit of a Korean patent application number 10-2021-0004603, filed on Jan. 13, 2021, in the Korean Intellectual Property Office, the disclosure of which is incorporated by reference herein in its entirety.

### BACKGROUND

### Field

The disclosure relates to an electronic apparatus and a method for controlling thereof. More particularly, the disclosure relates to an electronic apparatus that assists in participating in an auction for advertising content, and a method for controlling thereof.

In addition, the disclosure relates to an artificial intelligence (AI) system that simulates functions such as cognition and determination of a human brain using a machine learning algorithm, and its application.

### Description of Related Art

An artificial intelligence system is a computer system that implements human-level intelligence, and a machine learns and determines itself, and a recognition rate improves as it is used.

Artificial intelligence technology consists of machine learning (deep learning) technology that uses an algorithm that classifies/learns features of input data by itself, and elemental technologies that simulate functions of human brain's cognition and determination using machine learning algorithms.

Elemental technologies may include at least one of linguistic understanding technology that recognizes human language/text, visual understanding technology that recognizes objects as human eyes, inference/predicting technology that logically infers and predicts by determining information, knowledge expression technology that processes human experience information as knowledge data, and a motion control technology that controls a movement of a robot.

Recently, as various electronic apparatuses are developed, a consumption of content is increasing exponentially. Particularly, a lot of video contents are being consumed, and advertising contents are being played between video contents or while the video contents are being played.

Such advertising contents have been provided to viewers through a real-time auction system as shown in FIG. 1 in the related art. When a viewer accesses a Publisher's platform, a supply-side platform (SSP) transmits a signal (Ad Request at operation 1) requesting an advertisement to be shown, to the viewer to AD Exchange, and the AD Exchange transmits a signal (Bid Request at operation 2) requesting a price for an advertising space to a plurality of demand-side platforms (DSP) connected, to the AD Exchange. Each of the plurality of DSPs calculates a bid price for the advertisement space on behalf of a plurality of advertisers and transmits the highest price (Bid Response at operation 3) to the AD Exchange. The AD Exchange transmits a win notice (at operation 4) to a DSP that submits the highest price among the plurality of DSPs. The DSP receiving the win notice provides advertisements to the viewer through AD Server (at operation 5).

In this case, the bid price is determined based on information input by the advertiser, but the information input by the advertiser is only simple information such as an upper limit of the bid price. In other words, the conventional advertiser inputs information related to a bid price without considering information on viewers at all. Accordingly, there has been a need to provide advertisements by more targeting viewers.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus that provides more various information to an advertiser, such as advertisement participation information of a viewer in a process of participating in an auction for advertising content.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a communication circuitry, a memory configured to store a first neural network model, and a processor configured to be connected to the communication circuitry and the memory to control the electronic apparatus, wherein the processor is configured to, based on a price request signal for advertising content to be provided to a viewer being received from an external device through the communication circuitry, obtain first information related to the viewer based on the price request signal, input the first information, second information on a target viewer and target viewing content set by an advertiser of the advertising content into the first neural network model to obtain an expected participation degree in the advertising content of the viewer, and determine whether to respond to the price request signal based on the expected participation degree.

The processor may be configured to determine whether to respond to the price request signal based on the third information, a target participation degree set by the advertiser, and the expected participation degree.

The processor may be configured to, based on the target participation degree being not set by the advertiser, obtain the target participation degree based on an entire play time of the advertising content included in the third information.

The memory is configured to further store a second neural network model, wherein the processor may be configured to, based on responding to the price request signal being determined, input the third information, the target participation degree set by the advertiser, and the expected participation degree, into the second neural network model to obtain a price for the advertising content, and control the communication circuitry to transmit the obtained price to the external device.

The memory is configured to further store a third neural network model, wherein the processor may be configured to input the first information into the third neural network model to obtain an expected price for advertising content of another advertiser, determine whether to respond to the price request signal based on the expected participation degree and the expected price, and based on responding to the price request signal being determined, input the third information, the target participation degree set by the advertiser, the expected participation degree, and the expected price into the second neural network model, to obtain a price for the advertising content.

The processor may be configured to transmit the obtained price to the external device by controlling the communication circuitry, to participate in an auction to determine advertising content to be provided to the viewer, and receive a result of the auction from the external device through the communication circuitry.

The processor may be configured to, based on the advertising content being awarded, control the communication circuitry to provide the advertising content to the viewer, and based on the advertising content being not awarded, change the target participation degree.

The processor may be configured to obtain at least one of the viewer's age, gender, location, nationality, or occupation, and identify the obtained information as the first information.

The expected participation degree is configured to represent a ratio of time that an entire advertising content can be regarded as being viewed to a time that the viewer is expected to watch the advertising content.

In accordance with another aspect of the disclosure, a method for controlling an electronic apparatus is provided. The method includes based on a price request signal for advertising content to be provided to a viewer being received from an external device, obtaining first information related to the viewer based on the price request signal, inputting the first information, second information on a target viewer and target viewing content set by an advertiser of the advertising content into a first neural network model to obtain an expected participation degree in the advertising content of the viewer, and determining whether to respond to the price request signal based on the expected participation degree.

The determining may include determining whether to respond to the price request signal based on the third information, a target participation degree set by the advertiser, and the expected participation degree.

The determining may include, based on the target participation degree being not set by the advertiser, obtaining the target participation degree based on an entire play time of the advertising content included in the third information.

The method may be further comprising: based on responding to the price request signal being determined, inputting the third information, the target participation degree set by the advertiser, and the expected participation degree, into a second neural network model to obtain a price for the advertising content; and transmitting the obtained price to the external device.

The method may be further comprising: inputting the first information into a third neural network model to obtain an expected price for advertising content of another advertiser, wherein the determining includes determining whether to respond to the price request signal based on the expected participation degree and the expected price, and wherein the obtaining the price includes, based on responding to the price request signal being determined, inputting the third information, the target participation degree set by the advertiser, the expected participation degree, and the expected price into the second neural network model, to obtain a price for the advertising content.

The transmitting may include transmitting the obtained price to the external device to participate in an auction to determine advertising content to be provided to the viewer, and wherein the control method further includes receiving a result of the auction from the external device.

In accordance with another aspect of the disclosure, a non-transitory computer-readable recording medium in which a program for executing a method of operating an electronic apparatus is stored, is provided. The method includes, based on a price request signal for advertising content to be provided to a viewer being received from an external device, obtaining first information related to the viewer based on the price request signal, inputting the first information, second information on a target viewer and target viewing content set by an advertiser of the advertising content into a first neural network model to obtain an expected participation degree in the advertising content of the viewer, and determining whether to respond to the price request signal based on the expected participation degree.

In accordance with another aspect of the disclosure, an electronic apparatus is provided. The electronic apparatus may assist the advertiser to participate in an auction for the advertising content by providing the viewer's expected participation degree for the advertising content of the advertiser.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating related art;

FIG. 2A is a block diagram illustrating a configuration of an electronic apparatus according to an embodiment of the disclosure;

FIG. 2B is a block diagram illustrating a detailed configuration of an electronic apparatus according to an embodiment of the disclosure;

FIGS. 3, 4, and 5 are views illustrating an auction system according to various embodiments of the disclosure;

FIG. 6 is a view illustrating a method of learning a first neural network model according to an embodiment of the disclosure;

FIGS. 7A and 7B are views illustrating a method of learning a neural network model for outputting a response according to various embodiment of the disclosure;

FIGS. 8A and 8B are views illustrating a method of learning a second neural network model according to various embodiment of the disclosure; and

FIG. 9 is a flowchart illustrating a method of controlling an electronic apparatus according to an embodiment of the disclosure.

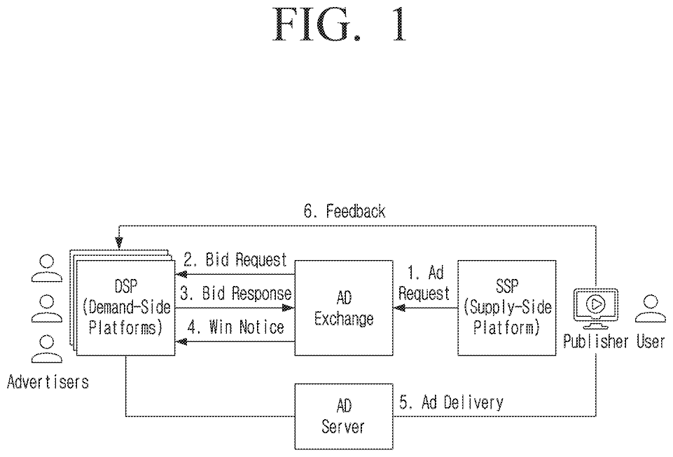

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims is not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

Terms used in the disclosure are selected as general terminologies currently widely used in consideration of the configuration and functions of the disclosure, but can be different depending on intention of those skilled in the art, a precedent, appearance of new technologies, and the like. Further, in specific cases, terms may be arbitrarily selected. In this case, the meaning of the terms will be described in the description of the corresponding embodiments. Accordingly, the terms used in the description should not necessarily be construed as simple names of the terms, but be defined based on meanings of the terms and overall contents of the disclosure.

It is to be understood that the singular forms “a,” “an,” and “the” include plural referents unless the context clearly dictates otherwise. Thus, for example, reference to “a component surface” includes reference to one or more of such surfaces.

The terms “have”, “may have”, “include”, and “may include” used in the embodiments of the disclosure indicate the presence of corresponding features (for example, elements such as numerical values, functions, operations, or parts), and do not preclude the presence of additional features.

In the description, the term “A or B”, “at least one of A or/and B”, or “one or more of A or/and B” may include all possible combinations of the items that are enumerated together.

The expression “1”, “2”, “first”, or “second” as used herein may modify a variety of elements, irrespective of order and/or importance thereof, and only to distinguish one element from another. Accordingly, without limiting the corresponding elements.

Singular forms are intended to include plural forms unless the context clearly indicates otherwise. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

Also, the term “user” may refer to a person who uses an electronic apparatus or an apparatus (e.g., an artificial intelligence (AI) electronic apparatus) that uses the electronic apparatus.

Hereinafter, exemplary embodiments will be described in greater detail with reference to the accompanying drawings.

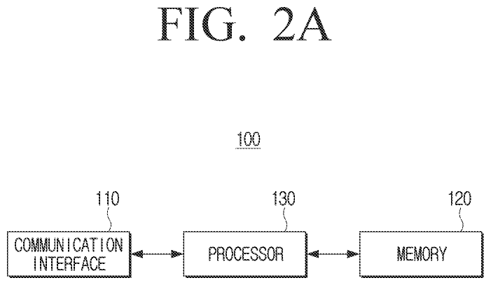

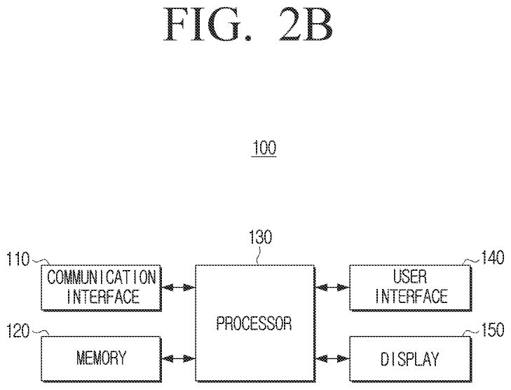

FIG. 2A is a block diagram illustrating an electronic apparatus according to an embodiment of the disclosure.

The electronic apparatus 100 is a device that processes an operation related to auction bidding of advertising content, and may be a device such as a server, a TV, a desktop PC, a notebook, a video wall, a large format display (LFD), a digital signage, a digital information display (DID), a projector display, a digital video disk (DVD) player, a smartphone, a tablet PC, a monitor, a smart glasses, a smart watch, a set-top box (STB), a speaker, a computer body, or the like. However, it is not limited thereto, and the electronic apparatus 100 may be any device as long as it can process an operation related to auction bidding of advertising content.

Referring to FIG. 2A, electronic apparatus 100 includes a communication interface 110, a memory 120 and a processor 130.

The communication interface 110 may be an element that communicates or interfaces with various external apparatuses according to various types of communication methods. For example, the electronic apparatus 100 may communicate with AD Exchange or electronic devices of a plurality of advertisers through the communication interface 110.

The communication interface 110 may include a wireless fidelity (Wi-Fi) module, a Bluetooth module, an infrared communication module, and a wireless communication module. Here, each communication module may be implemented in a form of at least one hardware chip.

Especially, the Wi-Fi module and Bluetooth module each performs communication in the Wi-Fi method, and Bluetooth method, respectively. If the Wi-Fi module or the Bluetooth module is used, various kinds of connection information such as a subsystem identification (SSID), a session key or the like is transmitted and received first, and after establishing communication, various kinds of information may be transmitted and received. The infrared communication module performs communication according to an infrared data association (IrDA) technology, which wirelessly transmits data in a short distance using infrared rays between sight rays and millimeter waves.

In addition to the communication methods described above, the wireless communication module may include at least one communication chip that performs communication according to various wireless communication standards such as ZigBee, 3^{rd} Generation (3G), 3^{rd} generation partnership project (3GPP), long term evolution (LTE), LTE Advanced (LTE-A), 4th Generation (4G), 5th generation (5G), or the like.

Alternatively, the communication interface 110 may include a wired communication interface such as HDMI, DP, Thunderbolt, USB, RGB, D-SUB, DVI, or the like.

In addition, the communication interface 110 may include at least one of a local area network (LAN) module, an Ethernet module, or a wired communication module for performing communication using a pair cable, a coaxial cable, an optical fiber cable, or the like.

The memory 120 may refer to hardware that stores information such as data or the like in an electrical or magnetic form such that the processor 130 or the like can access it. For this operation, the memory 120 may be implemented as at least one of a non-volatile memory, a volatile memory, a flash memory, a hard disk drive (HDD) or a solid state drive (SSD), RAM, and ROM.

At least one instruction or module required for the operation of the electronic apparatus 100 or the processor 130 may be stored in the memory 120. Here, the instruction may be a unit of code indicating the operation of the electronic apparatus 100 or the processor 130, and may be written in machine language, which is a language that can be understood by a computer. The module may be a set of instructions that perform a specific task in a unit of work.

The memory 120 may store data, which is information in units of bits or bytes capable of representing characters, numbers, images, or the like. For example, a plurality of neural network models may be stored in the memory 120. The plurality of neural network models may include a model that is trained to obtain a viewer's expected participation in advertising content, a model that is trained to acquire a price for advertising content, a model that acquires a predicted price for advertising content of other advertisers, or the like.

The memory 120 may be accessed by the processor 130, and perform readout, recording, correction, deletion, update, and the like, on data by the processor 130.

The processor 130 controls a general operation of the electronic apparatus 100. The processor 130 may be connected to each component of the electronic apparatus 100 to control overall operations of the electronic apparatus 100. For example, the processor 130 may be connected to components such as the communication interface 110 and the memory 120 to control the operation of the electronic apparatus 100.

According to an embodiment, the processor 130 may be implemented as a digital signal processor (DSP), a microprocessor, or a time controller (TCON), but is not limited thereto, and the processor may include or may be defined by at least one of a central processing unit (CPU), microcontroller unit (MCU), micro processing unit (MPU), controller, application processor (AP), communication processor (CP), ARM processor. In addition, the processor 130 may be implemented as a System on Chip (SoC), large scale integration (LSI) with a built-in processing algorithm, or may be implemented in a form of a field programmable gate array (FPGA).

When a price request signal for advertising content to be provided to a viewer is received from an external device through the communication interface 110, the processor 130 may obtain first information related to the viewer based on the price request signal.

For example, when a price request signal for advertising content to be provided to the viewer is received from AD Exchange through the communication interface 110, the processor 130 may identify at least one of the viewer's age, gender, location, nationality, or occupation as the first information based on the price request signal.

The processor 130 may input first information, second information on a target viewer and target viewing content set by the advertiser of the advertising content, and third information on the advertising content into a first neural network model to acquire a viewer engagement measure (VEM) for the viewer's advertising content. For example, an expected participation rate may represent a ratio of a time that an entire advertising content can be regarded as being viewed to a time that the viewer is expected to watch the advertising content, and may be determined as a real number between 0 and 1. Here, the second information may include information on the type of content the viewer is watching, broadcasting station, viewing age, genre, or the like, and the third information may include information on the type of advertising content, a product targeted for advertisement, or the like. In addition, the first neural network model may be a model that learns a relationship between first sample information for viewers, second sample information for target viewing content, and third sample information for advertising content and sample participation.

The processor 130 may determine whether to respond to the price request signal based on the expected participation rate. For example, when the expected participation rate is 0.7 or more, the processor 130 may determine to participate in an auction in response to the price request signal.

Alternatively, the processor 130 may determine whether to respond to the price request signal based on the third information, the target participation rate set by the advertiser, and the expected participation rate. For example, the processor 130 may determine to participate in the auction in response to the price request signal when the expected participation rate is greater than or equal to the target participation rate set by the advertiser. In this case, the target participation rate set by the advertiser may be different according to the third information. For example, when the advertising content is an oral advertisement, a target participation rate set by the advertiser may be 0.5, and when the advertising content is a clothing advertisement, a target participation rate set by the advertiser may be 0.7.

Alternatively, if the advertiser does not set the target participation rate, the processor 130 may acquire the target participation rate based on an entire play time of the advertising content included in the third information.

Meanwhile, the memory 120 may further store a second neural network model, and when it is determined to respond to the price request signal, the processor 130 may control the communication interface 110 to input the third information, the target participation rate set by the advertiser, and the expected participation rate into the second neural network model and obtain a price for advertising content, and transmit the obtained price to an external device. Here, the second neural network model may be a model that learns a relationship between third sample information for the advertising content, sample target participation, and relation between the expected sample participation rate and price.

In addition, the memory 120 may further store a third neural network model, and the processor 130 may input the first information into the third neural network model to obtain a predicted price for advertising contents of other advertisers, and determine whether to respond to the price request signal based on the expected participation rate and expected price. Here, the third neural network model may be a model in which a relationship between the first sample information on the viewer and the sample price of the other advertiser is learned.

When it is determined that the processor 130 responds to the price request signal, the processor 130 may input the third information, the target participation rate set by the advertiser, the expected participation rate, and the predicted price into the second neural network model to obtain a price for the advertising content. In other words, the second neural network model may be learned by further considering the predicted price for the other advertisers.

The processor 130 may control the communication interface 110 to transmit the obtained price to an external device to participate in an auction which determines advertising content that will be provided to the viewer, and receive a result of the auction from an external device through the communication interface 110.

Meanwhile, the processor 130 may control the communication interface 110 to provide the advertising content to the viewer when the advertising content is awarded, and change the target participation rate when the advertising content is not awarded.

For example, when the advertising content is awarded, the processor 130 may control the communication interface 110 to transmit a signal instructing the viewer to provide the advertising content to the AD server. Alternatively, the processor 130 may change a current target participation rate of 0.7 to 0.69 when the advertising content is not awarded. As the target participation rate decreases, the price for content acquired using the second neural network model may decrease.

In addition, the processor 130 may change the target participation rate based on the number of times that has not been awarded. For example, if the number of times that has not been awarded exceeds 3, the processor 130 may change the current target participation rate of 0.7 to 0.69. Here, when the target participation rate is changed, the number of times that that has not been awarded may be set to 0 again.

FIG. 2B is a block diagram illustrating a structure of an electronic apparatus, according to an embodiment of the disclosure. An electronic apparatus 100 may include a communication interface 110, a memory 120, and a processor 130. In addition, referring to FIG. 2B, the electronic apparatus 100 may further include at least one of a user interface 140 and a display 150. Detailed descriptions of constitutional elements illustrated in FIG. 2B that are redundant with constitutional elements in FIG. 2A are omitted.

The user interface 140 may be implemented to be device such as button, touch pad, mouse and keyboard, or may be implemented to be touch screen that can also perform the function of the display 150. The button may include various types of buttons, such as a mechanical button, a touch pad, a wheel, etc., which are formed on the front, side, or rear of the exterior of a main body. The advertiser may input information related to bidding through the user interface 140.

The display 150 may be implemented as various types of displays, such as a liquid crystal display (LCD), an organic light emitting diodes (OLED) display, and a plasma display panel (PDP), or the like. The display 150 may include a driving circuit, a backlight unit, or the like which may be implemented in forms such as an a-si TFT, a low temperature poly silicon (LTPS) TFT, an organic TFT (OTFT), and the like. The display 150 may be realized as a plasma display panel (PDP), a liquid crystal display (LCD), an organic light emitting diode (OLED), a flexible display, a 3-dimensional (3D) display, or the like.

Meanwhile, functions related to artificial intelligence according to the disclosure are operated through the processor 130 and the memory 120.

The processor 130 may be composed of one or a plurality of processors. In this case, one or more processors may be a general-purpose processor such as a CPU, AP, or DSP, a graphics-only processor such as a graphics processing unit (GPU) or a vision processing unit (VPU), or an artificial intelligence-only processor such as an NPU.

One or more processors control to process input data according to a predefined operation rule or an artificial intelligence model stored in the memory 120. Alternatively, when one or more processors are dedicated artificial intelligence processors, the artificial intelligence dedicated processor may be designed with a hardware structure specialized for processing a specific artificial intelligence model. A predefined operation rule or an artificial intelligence model is characterized by being generated through learning.

Here, the generated through learning means that a basic artificial intelligence model is learned using a plurality of learning data by a learning algorithm, such that a predefined operation rule or artificial intelligence model set to perform a desired characteristic (or purpose) is generated. Such learning may be performed in a device on which artificial intelligence according to the disclosure is performed, or may be performed through a separate server and/or system. Examples of the learning algorithm include supervised learning, unsupervised learning, semi-supervised learning, or reinforcement learning, but are not limited to the examples described above.

The artificial intelligence model may be composed of a plurality of neural network layers. Each of the plurality of neural network layers has a plurality of weight values, and a neural network operation is performed through an operation result of a previous layer and a plurality of weight values. The plurality of weight values of the plurality of neural network layers may be optimized by the learning result of the artificial intelligence model. For example, a plurality of weight values may be updated to reduce or minimize a loss value or a cost value acquired from the artificial intelligence model during the learning process.

The artificial neural network may include a deep neural network (DNN), for example, a convolutional neural network (CNN), a deep neural network (DNN), a recurrent neural network (RNN), a restricted Boltzmann machine (RBM), deep belief network (DBN), bidirectional recurrent deep neural network (BRDNN), generative adversarial network (GAN), deep Q-Networks, or the like, but are not limited thereto.

As described above, the electronic apparatus 100 may assist the advertiser in participating in an auction for the advertiser's advertising content by providing the viewer's expected participation degree for the advertiser's advertising content.

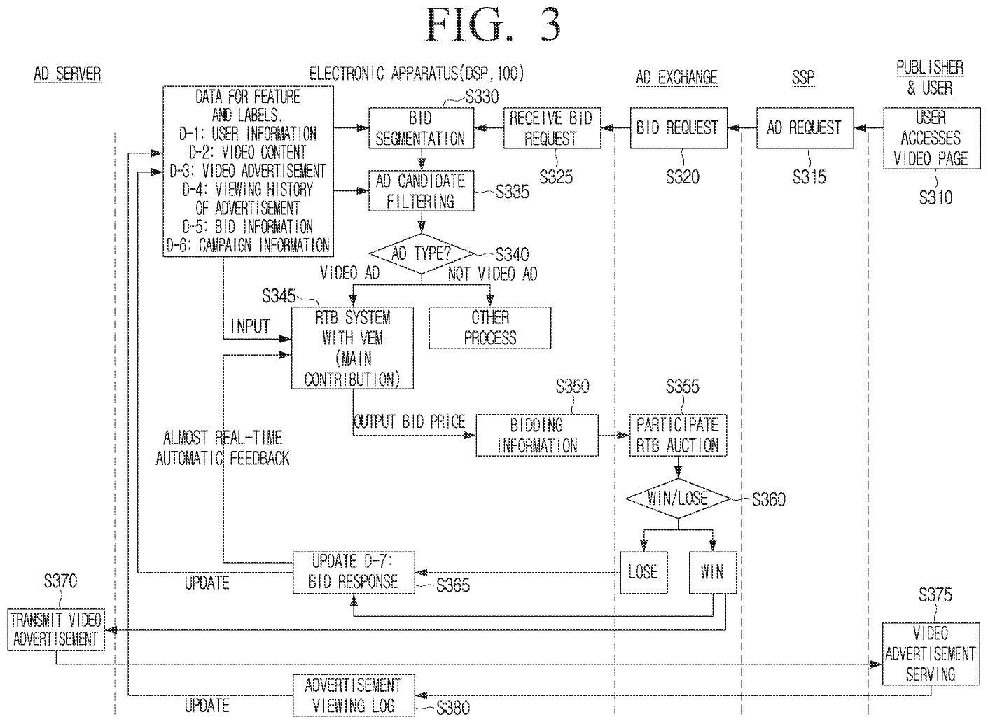

Hereinafter, the operation of the electronic apparatus 100 will be described in more detail with reference to FIGS. 3-6, 7A, 7B, 8A, and 8B. In FIGS. 3-6, 7A, 7B, 8A, and 8B, individual embodiments will be described for convenience of description. However, the individual embodiments of FIGS. 3-6, 7A, 7B, 8A, and 8B may be implemented in any number of combinations.

FIGS. 3 to 5 are views illustrating an auction system according to various embodiments of the disclosure.

Referring to FIG. 3, when a viewer accesses a video page (S310), a supply-side platform (SSP) may transmit a signal (Ad Request) for requesting an advertisement to be shown to the viewer to an AD Exchange (S315), and the AD Exchange may transmit a signal (Bid Request) for requesting a price for an advertisement space to an electronic apparatus 100 connected to the AD Exchange (S320). In this case, the AD Exchange may also transmit a signal requesting a price for the advertisement space to at least one other electronic apparatus 100 connected to the AD Exchange.

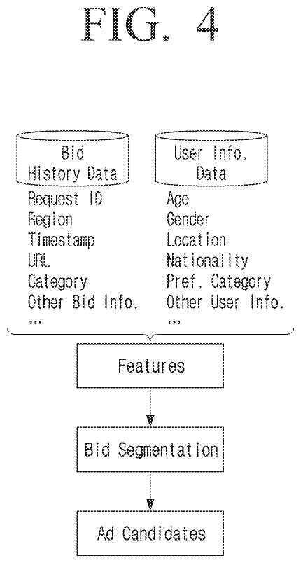

When a bid request signal is received from AD Exchange (S325), the processor 130 of the electronic apparatus 100 may perform a bidding segmentation (S330). Specifically, referring to FIG. 4, processor 130 may perform bidding segmentation based on bidding history and viewer information. For example, the processor 130 may identify a location, nationality, etc. of the viewer as first information based on an IP address included in the price request signal, and estimate a gender and age of the viewer as the first information based on the bidding history. The processor 130 may segment the bid based on the identified information and the estimated information. For example, the processor 130 may proceed with the bidding only when the viewer is 5 years or older. Through method described above, the processor 130 may identify Ad candidates to proceed with bidding for a plurality of price request signals.

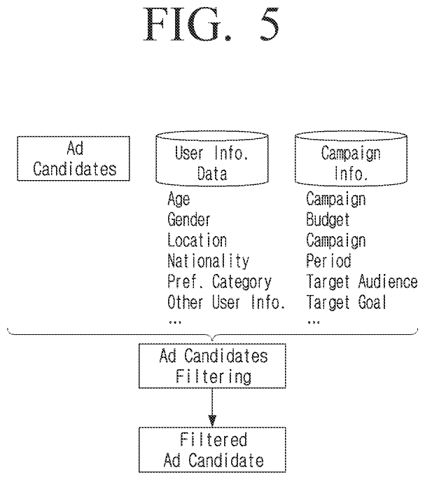

The processor 130 may filter candidates for bidding (S335). Referring to FIG. 5, processor 130 may filter candidates for bidding based on information on target viewers set by an advertiser, second information on target viewing content, and third information on advertising content. For example, when the age of the target viewer set by the advertiser is 30 years or older, the processor 130 may filter candidates whose viewers are under 30 years old.

The processor 130 may identify the type of advertising content (S340), and obtain an expected participation degree for the advertising content of the viewer (VEM Prediction, S345) when the type of advertising content is a video. In addition, the processor 130 may determine whether to respond to the price request signal based on the expected participation rate (VEM-based Throttling, S345), and may determine a price for the advertising content (Bid Price Decision, S345). For example, the processor 130 may obtain the viewer's expected participation degree for advertising content by using the first neural network model, and obtain a price for the advertising content by using the second neural network model.

In this case, the processor 130 may obtain a predicted price for the advertising content of the other advertiser and obtain a price for the advertising content based on the predicted price of the other advertiser. For example, the processor 130 may obtain a predicted price for the advertising content of the other advertiser using the third neural network model and obtain a price for the advertising content based on the predicted price of the other advertiser.

The processor 130 may perform the operation described above for a plurality of advertisers to obtain whether or not each of the plurality of advertisers responds and a price when responding. The processor 130 may participate in the auction of Ad Exchange by transmitting the highest price among a plurality of prices in response as bidding information (S350) to Ad Exchange (S355). The Ad Exchange may provide the auction result S360 to the electronic apparatus 100. The processor 130 may update the auction result (S365) and transmit a signal to AD server to provide an advertisement to the viewer. The AD Server may provide an advertisement to the publisher (S370), and the viewer may participate in the advertisement (S375).

The processor 130 may receive the advertisement participation degree of the viewer and update database (S380).

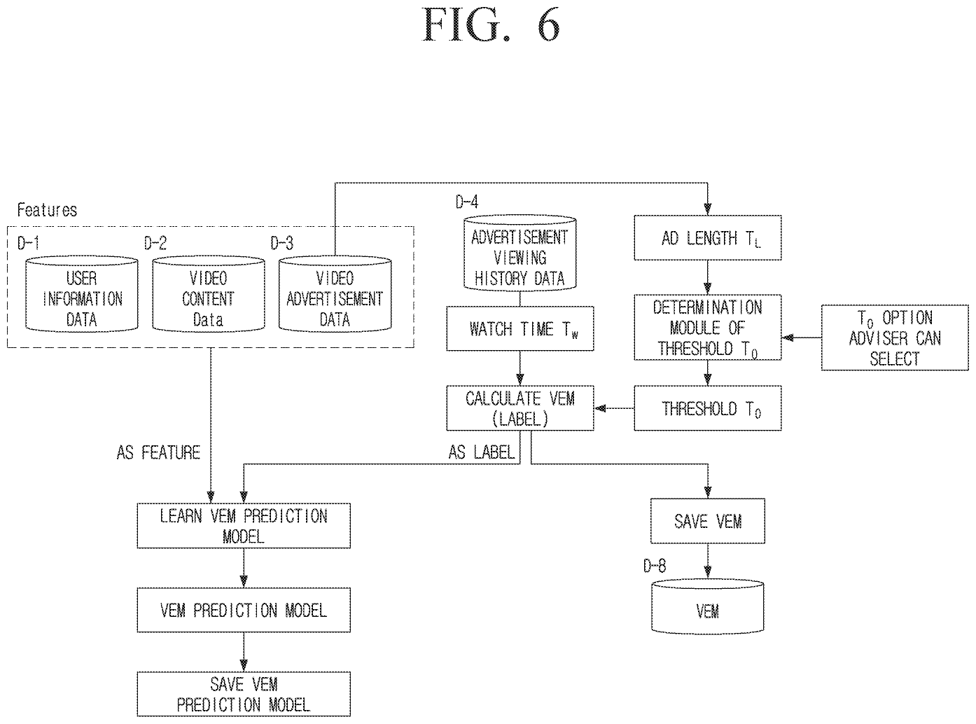

FIG. 6 is a view illustrating a method of learning a first neural network model according to an embodiment of the disclosure.

Referring to FIG. 6, a first neural network model is a model that outputs an expected participation degree of a viewer's advertising content, and processor 130 may identify an entire length (TL) of the advertising content, and obtain a time (To) at which the entire advertising content can be regarded as being viewed. The time (To) at which the entire advertising content can be regarded as being viewed may be selected by the advertiser or may be a preset value. Alternatively, the time (To) at which the entire advertising content can be regarded as being viewed may be defined as a ratio of an entire length (TL) of the advertising content or a function of the entire length of the advertising content.

The processor 130 may calculate a sample participation degree to be used in a learning process based on an actual viewer participation degree. For example, the sample participation rate (VEM) may be defined as in Equation 1 below.

VEM≡min(Tw,To)/To Equation 1

Here, Tw may be a time when a viewer has viewed the advertising content, and To may be a time at which the entire advertising content regarded as being viewed. Accordingly, the sample participation rate may have a value between 0 and 1.

As described above, the processor 130 may pre-store the advertisement participation degree of the viewer and use it for learning the first neural network model.

The processor 130 may learn the first neural network model through a relationship between the first sample information for the viewer, the second sample information for the target viewing content, and the third sample information for the advertising content and the sample participation degree.

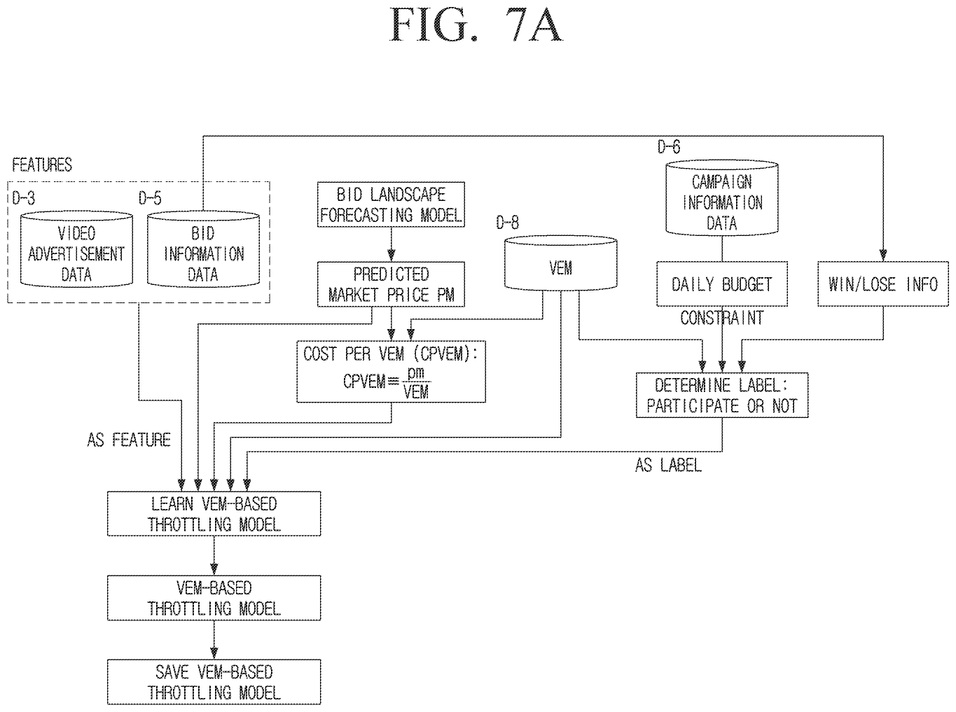

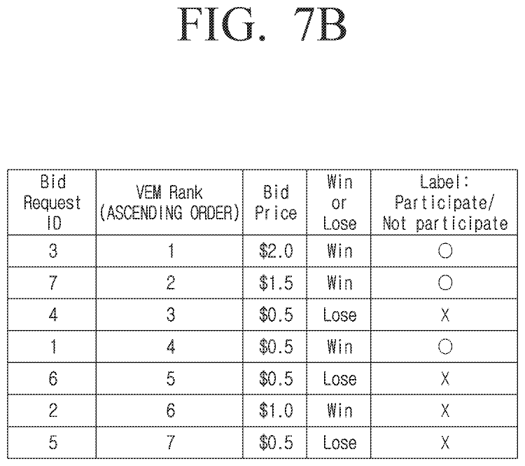

FIGS. 7A and 7B are views illustrating a method of learning a neural network model for outputting a response according to various embodiments of the disclosure.

Referring to FIG. 7B, a processor 130 may generate a database based on past bidding records. Specifically, the processor 130 may obtain a degree of participation (VEM), a bid price, and whether it is awarded, and add a label for whether or not it is awarded to use in the neural network model for outputting whether it responds. Here, the processor 130 may update the label on whether or not to be awarded among data to be used for learning by adding constraint conditions such as a budget limit, a period limit, and a unilateral budget limit.

Meanwhile, referring to FIG. 7A, a processor 130 may obtain a predicted price for advertising content of the other advertiser, and obtain an entire as a predicted market price (Pm). Further, the processor 130 may obtain a cost per VEM (CPVEM) that is a predicted market price per VEM through Equation 2 as follows.

CPVEM=Pm/VEM Equation 2

The processor 130 may perform learning of a neural network model that outputs whether to respond in consideration of third sample information for advertising content, bid information, Pm, CPVEM, participation rate (VEM), and a label on whether to be awarded. In this case, the processor 130 may perform a response based on a bid request having a low CPVEM.

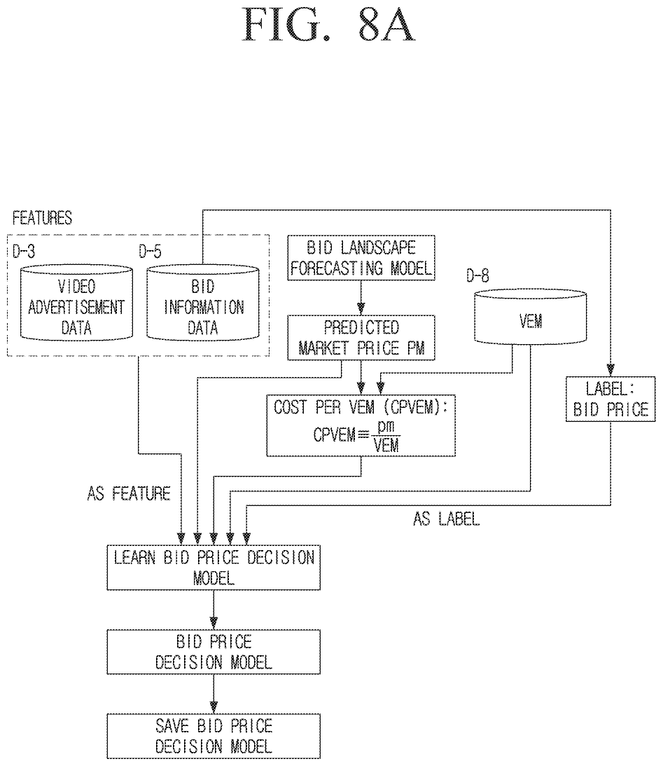

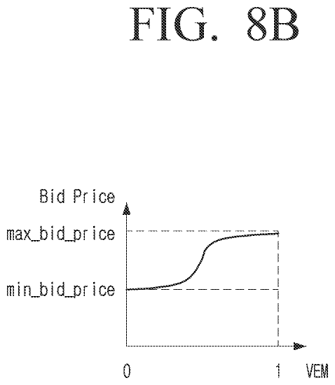

FIGS. 8A and 8B are views illustrating a method of learning a second neural network model according to various embodiments of the disclosure.

The second neural network model is a model that outputs a price for advertising content, and the processor 130 may learn a second neural network model through the relationship between third sample information, sample target participation rate, and expected sample participation rate for advertising content.

In addition, referring to FIG. 8A, a processor 130 may perform learning of a second neural network model by further considering bid information, Pm, and CPVEM.

Meanwhile, referring to FIG. 8B, a processor 130 may input the sample expected participation rate as a variable into a second neural network model and output a result. In this case, the advertiser may determine an appropriate price based on the result as shown in FIG. 8B.

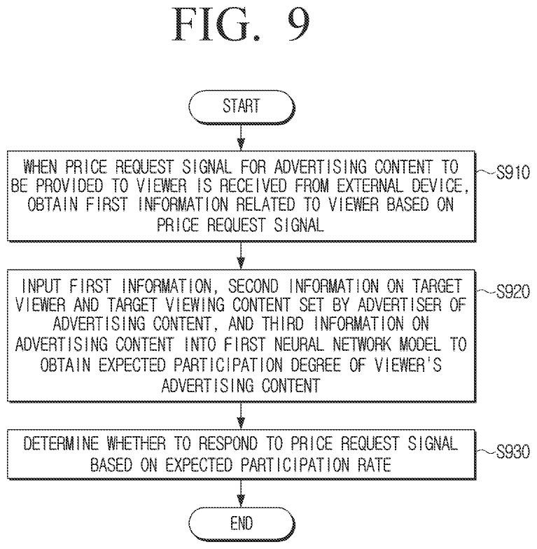

FIG. 9 is a flowchart illustrating a method of controlling an electronic apparatus according to an embodiment of the disclosure.

Referring to FIG. 9, when a price request signal for advertising content to be provided to a viewer is received from an external device, first information related to a viewer is obtained based on a price request signal at operation S910. In addition, an expected participation degree of the viewer's advertising content is obtained by inputting the first information, the second information on the target viewer and the target viewing content set by the advertiser of the advertising content, and the third information on the advertising content into the first neural network model at operation S920. In addition, it may be determined whether to respond to the price request signal based on the expected participation rate at operation S930.

Here, the determining operation S930 may determine whether to respond to the price request signal based on the third information, the target participation degree and the expected participation degree set by the advertiser.

In addition, the determining operation S930 may obtain the target participation rate based on an entire play time of the advertising content included in the third information when the advertiser does not set the target participation degree.

Meanwhile, if it is determined to respond to the price request signal, an operation of obtaining the price for the advertising content by inputting the third information, the target participation degree and the expected participation degree set by the advertiser into the second neural network model, and an operation of transmitting the obtained price to an external device may further be included.

Here, an operation of obtaining a predicted price for the advertising content of the other advertiser by inputting the first information into the third neural network model may be further included, the operation of determining at operation S930 may determine whether to respond for a price request signal based on the expected participation degree and the predicted price, and the operation of obtaining may obtain a price for the advertising content by inputting the third information, the target participation degree set by the advertiser, the expected participation degree, and the predicted price into the second neural network model when it is determined to respond to the price request signal.

The operation of transmitting may further include transmitting the obtained price to an external device to participate in an auction in which advertising content to be provided to the viewer, and the control method may further include receiving a result of the auction from the external device.

An operation of providing the advertising content to the viewer when the advertising content is awarded, and an operation of changing the target participation rate when the advertising content is not award may be further included.

Meanwhile, the operation of obtaining the first information at operation S910 may obtain at least one of the age, gender, location, nationality, or occupation of the viewer based on the price request signal, and identify the obtained information as the first information.

Here, the expected participation degree may represent a ratio of a time at which the viewer is expected to watch the advertising content to a time at which an entire advertising content is considered to be viewed.

According to various embodiments of the disclosure as described above, the electronic apparatus may assist the advertiser to participate in an auction for the advertising content by providing the viewer's expected participation degree for the advertising content of the advertiser.

According to an embodiment, the various embodiments described above may be implemented as software including instructions stored in a machine-readable storage media which is readable by a machine (e.g., a computer). The device may include the electronic device (e.g., electronic apparatus A) according to the disclosed embodiments, as a device which calls the stored instructions from the storage media and which is operable according to the called instructions. When the instructions are executed by a processor, the processor may directory perform functions corresponding to the instructions using other components or the functions may be performed under a control of the processor. The instructions may include code generated or executed by a compiler or an interpreter. The machine-readable storage media may be provided in a form of a non-transitory storage media. The ‘non-transitory’ means that the storage media does not include a signal and is tangible, but does not distinguish whether data is stored semi-permanently or temporarily in the storage media.

In addition, according to an embodiment, the methods according to various embodiments described above may be provided as a part of a computer program product. The computer program product may be traded between a seller and a buyer. The computer program product may be distributed in a form of the machine-readable storage media (e.g., compact disc read only memory (CD-ROM) or distributed online through an application store (e.g., PlayStore™). In a case of the online distribution, at least a portion of the computer program product may be at least temporarily stored or provisionally generated on the storage media such as a manufacturer's server, the application store's server, or a memory in a relay server.

Various exemplary embodiments described above may be embodied in a recording medium that may be read by a computer or a similar apparatus to the computer by using software, hardware, or a combination thereof. In some cases, the embodiments described herein may be implemented by the processor itself. In a software configuration, various embodiments described in the specification such as a procedure and a function may be embodied as separate software modules. The software modules may respectively perform one or more functions and operations described in the specification.

According to various embodiments described above, computer instructions for performing processing operations of a device according to the various embodiments described above may be stored in a non-transitory computer-readable medium. The computer instructions stored in the non-transitory computer-readable medium may cause a particular device to perform processing operations on the device according to the various embodiments described above when executed by the processor of the particular device. The non-transitory computer readable recording medium refers to a medium that stores data and that can be read by devices. For example, the non-transitory computer-readable medium may be CD, DVD, a hard disc, Blu-ray disc, USB, a memory card, ROM, or the like.

Further, each of the components (e.g., modules or programs) according to the various embodiments described above may be composed of a single entity or a plurality of entities, and some subcomponents of the above-mentioned subcomponents may be omitted or the other subcomponents may be further included to the various embodiments. Generally, or additionally, some components (e.g., modules or programs) may be integrated into a single entity to perform the same or similar functions performed by each respective component prior to integration. Operations performed by a module, a program module, or other component, according to various exemplary embodiments, may be sequential, parallel, or both, executed iteratively or heuristically, or at least some operations may be performed in a different order, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a communication circuitry;
a memory configured to store a first neural network model; and
a processor configured to be connected to the communication circuitry and the memory to control the electronic apparatus,
wherein the processor is further configured to:
based on a price request signal for advertising content to be provided to a viewer being received from an external device through the communication circuitry, obtain first information related to the viewer based on the price request signal,
input the first information, second information on a target viewer and target viewing content set by an advertiser of the advertising content into the first neural network model to obtain an expected participation degree in the advertising content of the viewer, and
determine whether to respond to the price request signal based on the expected participation degree.

2. The apparatus of claim 1, wherein the processor is further configured to determine whether to respond to the price request signal based on third information, a target participation degree set by the advertiser, and the expected participation degree.

3. The apparatus of claim 2, wherein the processor is further configured to, based on the target participation degree being not set by the advertiser, obtain the target participation degree based on an entire play time of the advertising content included in the third information.

4. The apparatus of claim 2,
wherein the memory is configured to further store a second neural network model, and
wherein the processor is further configured to:
based on responding to the price request signal being determined, input the third information, the target participation degree set by the advertiser, and the expected participation degree, into the second neural network model to obtain a price for the advertising content, and
control the communication circuitry to transmit the obtained price to the external device.

5. The apparatus of claim 4,
wherein the memory is configured to further store a third neural network model, and
wherein the processor is further configured to:
input the first information into the third neural network model to obtain an expected price for advertising content of another advertiser,
determine whether to respond to the price request signal based on the expected participation degree and the expected price, and
based on responding to the price request signal being determined, input the third information, the target participation degree set by the advertiser, the expected participation degree, and the expected price into the second neural network model, to obtain a price for the advertising content.

6. The apparatus of claim 5, wherein the processor is further configured to:
transmit the obtained price to the external device by controlling the communication circuitry,
participate in an auction to determine advertising content to be provided to the viewer, and
receive a result of the auction from the external device through the communication circuitry.

7. The apparatus of claim 6, wherein the processor is further configured to:
based on the advertising content being awarded, control the communication circuitry to provide the advertising content to the viewer, and
based on the advertising content being not awarded, change the target participation degree.

8. The apparatus of claim 1, wherein the processor is further configured to:
obtain information comprising at least one of the viewer's age, gender, location, nationality, or occupation, and
identify the obtained information as the first information.

9. The apparatus of claim 1, wherein the expected participation degree is configured to represent a ratio of time that an entire advertising content can be regarded as being viewed to a time that the viewer is expected to watch the advertising content.

10. A method for controlling an electronic apparatus comprising:
based on a price request signal for advertising content to be provided to a viewer being received from an external device, obtaining first information related to the viewer based on the price request signal;
inputting the first information, second information on a target viewer and target viewing content set by an advertiser of the advertising content into a first neural network model to obtain an expected participation degree in the advertising content of the viewer; and
determining whether to respond to the price request signal based on the expected participation degree.

11. The method of claim 10, wherein the determining comprises determining whether to respond to the price request signal based on third information, a target participation degree set by the advertiser, and the expected participation degree.

12. The method of claim 11, wherein the determining comprises, based on the target participation degree being not set by the advertiser, obtaining the target participation degree based on an entire play time of the advertising content included in the third information.

13. The method of claim 11, further comprising:
based on responding to the price request signal being determined, inputting the third information, the target participation degree set by the advertiser, and the expected participation degree, into a second neural network model to obtain a price for the advertising content; and
transmitting the obtained price to the external device.

14. The method of claim 13, further comprising:
inputting the first information into a third neural network model to obtain an expected price for advertising content of another advertiser,
wherein the determining comprises determining whether to respond to the price request signal based on the expected participation degree and the expected price, and
wherein the obtaining the price includes, based on responding to the price request signal being determined, inputting the third information, the target participation degree set by the advertiser, the expected participation degree, and the expected price into the second neural network model, to obtain a price for the advertising content.

15. The method of claim 14,
wherein the transmitting comprises transmitting the obtained price to the external device to participate in an auction to determine advertising content to be provided to the viewer, and
wherein the method further comprises receiving a result of the auction from the external device.
